(19) United States
(12) Patent Application Publication
(10) Pub. No.: US 2026/0235987 A1
(43) Pub. Date: Aug. 13, 2026

(54) DEVICE FOR PRODUCING A POLYCHROMATIC HOLOGRAPHIC IMAGE IN A SEAT TRIM PANEL

(71) Applicant: CARL ZEISS JENA GMBH, Jena (DE)

(72) Inventor: Siemen KUEHL, Jena (DE)

(21) Appl. No.: 19/156,859

(22) PCT Filed: Feb. 15, 2024
(86) PCT No.: PCT/EP2024/053819

§ 371 Date: Aug. 14, 2025

(30) Foreign Application Priority Data
Feb. 17, 2023 (DE) 10 2023 103 962.8

(51) Int. Cl. G03H 1/26; G03H 1/00

(52) U.S. Cl. CPC G03H 1/265; G03H 1/0005; G03H 2001/266; G03H 2222/12; G03H 2222/18; G03H 2222/34; G03H 2223/16; G03H 2223/24

(57) ABSTRACT

A device with a holographic structure for creating a polychromatic holographic image has a light guide with a first and a second input coupling regions and a first and a second light sources. The latter respectively radiate light of a first and a second wavelength ranges into the first and second input coupling regions. The holographic structure creates a polychromatic holographic image under illumination with light from the first and the second light sources. The holographic structure has a first and a second regions that are respectively wavelength-selective for light of the first and second wavelength ranges. The light guide is also configured to guide the light from the first and second light sources to the first and second regions, respectively.

Also disclosed are a light guide for the device, a vehicle seat with a seat trim panel including the device, and a vehicle with the vehicle seat.

The invention relates to a device for creating a polychromatic holographic image. To this end, the device comprises a light guide comprising a first input coupling region and a second input coupling region. Furthermore, a first light source and a second light source are present, wherein the first light source radiates light of a first wavelength range into the first input coupling region, and the second light source radiates light of a second wavelength range into the second input coupling region. The device comprises a holographic structure, which creates a polychromatic holographic image under illumination by means of light from the first light source and the second light source. The holographic structure is characterized in that it is subdivided into a first region and a second region, the first region being wavelength-selective for light of the first wavelength range and the second region being wavelength-selective for light of the second wavelength range. The light guide is also configured to guide the light from the first light source to the first region and the light from the second light source to the second region.

In further aspects, the invention relates to a light guide for the device according to the invention, a vehicle seat comprising a seat trim panel, in which the device according to the invention is integrated, and a vehicle comprising such a vehicle seat.

### BACKGROUND AND PRIOR ART

Holography is a branch of optics which considers the production and construction of three-dimensional, virtual or real images and which can be considered to be an extension of photography. While a photographic image is only a two-dimensional representation of an object, holography leads to three-dimensional representations. In addition to the intensity of the imaged object, phase relationships of the light coming from the object are also recorded and stored-in contrast with photography. These phase relationships contain additional spatial information, whereby a three-dimensional impression of the image can be created. This is brought about by the interference of light beams while the object is being recorded. The object is illuminated using coherent light and is reflected off and scattered by the object. The resulting wave field, the so-called object wave, is overlaid with light coherent with the object wave, the so-called reference wave, and so the wave fields interfere with each other depending on their phase relationship. The resulting interference pattern can be recorded, e.g. by means of a light-sensitive layer, and so the information contained in the phase is also stored. To reconstruct the image, the resultant hologram can be illuminated using a light wave that is identical or similar to the reference wave and diffracted by the recorded interference pattern. The original wavefront of the object wave may thus be reconstructed.

Holograms and the holographic images that can be displayed for an observer are known for various state-of-the-art applications, for example as security features on credit cards, banknotes or for product presentations. It should usually be possible to create such holograms even by passive illumination by way of incoherent daylight, whereby, however, only a reduced quality is usually achieved.

By contrast, the creation of holographic images by means of light sources that allow illumination with greater spatial and temporal coherence is also known, this serving to display three-dimensional images that are of much higher quality and preferably visible to the observer from different viewing angles.

Such display devices are particularly popular in automotive and aeronautic applications. Displays in these fields should reproduce information, which is as clear and as perceptible as possible, without quality of the depicted content suffering or having an overly abstract character. For practical reference, multicolored displays, i.e. polychromatic displays, are relevant in particular, in order to convey different contents to an observer in a simple way by means of appropriate coloring. For example, multiple holographic images that have different colors can be created for this purpose. The prior art contains various approaches for allowing the creation of polychromatic holographic images for an observer.

DE 102021200543 A1 discloses a device capable of creating two holographic images. One or more light sources that emit light into the input coupling surface of a light guide are used to this end. The light then is input coupled into the light guide, whereupon a beam path for illuminating a holographic structure is formed. Radiation can be output coupled by means of the holographic structure in order to create a holographic image. The holographic structure may form a part of the output coupling region where the light is output coupled. In DE 102021200543A1 , the output coupling region is a single shared region, i.e. a single region is used for the creation of two color channels of a holographic image.

The use of a single light source that can illuminate a holographic structure of a light guide in order to produce a polychromatic holographic image is also known. In this case, the light source is preferably designed to emit light in different wavelength ranges. For example, this may be an RGB LED. A holographic structure can be provided in the light guide on an output coupling surface. After the polychromatic light of the light source has been input coupled, it is guided to the output coupling surface of the light guide and hence to the holographic structure. The holographic structure has a selectivity for at least two different color channels or wavelength ranges, and so a polychromatic holographic image can be provided under appropriate illumination of the holographic structure.

Although these approaches allow reliable creation of polychromatic holographic images, they may also have disadvantages. In particular, it was found that so-called ghost images might be created when a holographic structure designed for two color channels is illuminated. For example, a ghost image is an unwanted color smear that occurs in the holographic image. This may result in particular from a mutual influence of different color channels, i.e. from the mutual influence of light channels that are designed to specify the beam path of light of a wavelength or a wavelength range within the light guide.

The holographic structure is designed to be wavelength-selective for the respective color channels. In the implementation, however, an occurrence of crosstalk between different color channels cannot be ruled out. In order to reduce this, it is possible in principle to optimize the quality of the holographic image to be displayed by virtue of adapting an angle of incidence of the illumination radiation. For example, a smaller or steeper angle of incidence may result in a higher selectivity of the holographic structure and hence result in selectivity between the color channels.

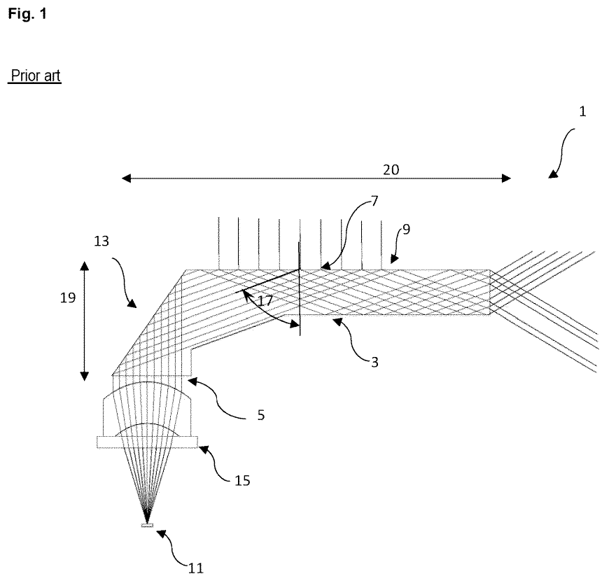

However, the adaptation of an angle of incidence may affect the required geometric dimensions of a light guide or the overall device, as evident from FIG. 1, for example. For a light guide with a deflection surface for guiding the radiation to an output coupling surface with holographic structure, a smaller or steeper angle of incidence usually requires a larger distance from the light source or an increase in the light guide size. The result is an increase in the installation depth required for the entire device, which may be problematic especially for applications in the automotive and aviation industry due to the limited installation space available.

Therefore, there is a need in the prior art for alternative or improved devices for the creation of polychromatic holographic images.

### Problem Addressed by the Invention

The problem addressed by the invention was that of eliminating the disadvantages of the prior art. In particular, a problem addressed by the invention was that of providing a device for creating polychromatic holographic images that ensures low crosstalk between different color channels by simple means and is simultaneously distinguished by a compact design.

### SUMMARY OF THE INVENTION

The problem is solved by the independent claims. Preferred embodiments of the invention are described in the dependent claims.

In a first aspect, the invention relates to a device for creating a polychromatic holographic image, comprising
a. a light guide comprising a first input coupling region and a second input coupling region for input coupling light into the light guide,
b. a first light source designed to radiate light of a first wavelength range into the first input coupling region,
c. a second light source designed to radiate light of a second wavelength range into the second input coupling region,
d. a holographic structure for creating the polychromatic holographic image under illumination by means of the first and second light sources,
   characterized in that the holographic structure has a first region, which is wavelength-selective for light of the first wavelength range, and a second region, which is wavelength-selective for light of the second wavelength range, and wherein the light guide is configured to guide the light from the first light source to the first region of the holographic structure and the light from the second light source to the second region of the holographic structure.

By means of the device according to the invention, a particularly low crosstalk between different color channels is advantageously ensured during the creation of a polychromatic holographic image. By dividing the holographic structure into a first region and second region, which are wavelength-selective for the light from the first light source and the second light source, respectively, there is a clear separation of the positioning, the wavelength and the angle with which the first region and the second region are irradiated. This reduces the influence of the color channels within the light guide, resulting in a corresponding reduction of the crosstalk. Ghost images, which may arise as color smears or in the form of double images in polychromatic holographic images, are effectively avoided.

Hence, the device allows the creation of a particularly high-quality polychromatic holographic image, which can reproduce optical contents of different colors clearly and precisely.

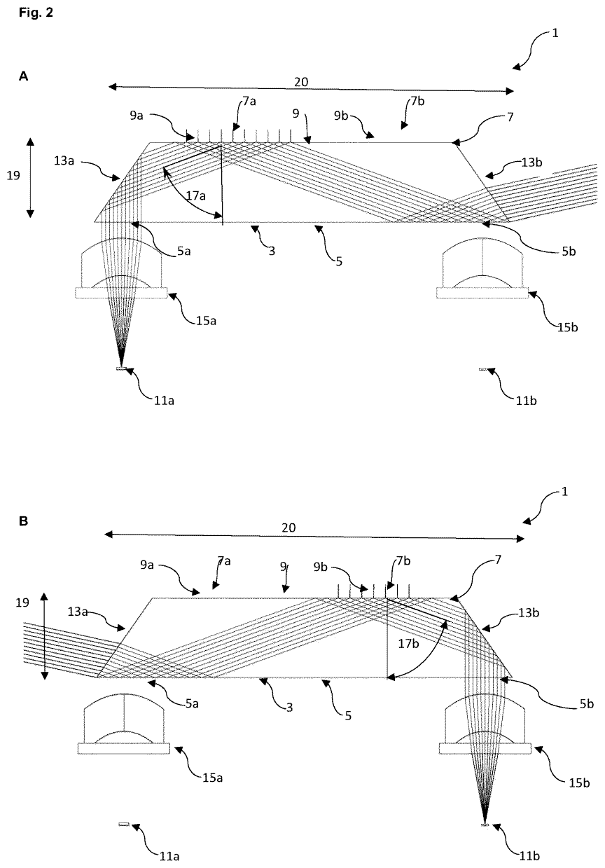

Advantageously, the components can simultaneously be arranged in such a way that the device requires only an extremely small installation space. A sharp separation of the color channels over a greater range of angles of incidence is achieved in particular by using two light sources and dividing the holographic structure into two regions. In particular, it is thus possible to achieve sufficient separation even in the event of relatively flat or large angles of incidence. As evident from FIG. 2, particularly small dimensions for the light guide or the entire device may be provided as a result. In this respect, it is also advantageous that in comparison with an illumination using a single beam source, it is possible to use beams with a smaller cross section for the illumination of the separate regions of the holographic structure by the respective light source. The installation space depth can additionally be reduced by reducing the size of the hologram regions to be illuminated. As evident from the comparison of two variants with one light source (FIG. 1) and two light sources (FIG. 2), the reduction of a cross section of a beam of the illumination radiation allows reductions both in an extent of the deflection surface in the light guide and in the extent of the light guide as such.

This results in considerable savings in terms of space, and a particularly compact configuration of the device, which can be used especially in regions where only little installation space is available, is obtained.

In addition, it is advantageous that the use of two light sources allows an intensity of the illumination of the separate regions of the holographic structure to be set independently of each other. In particular, therefore, brightness levels of the holographic image at a specific wavelength as created by the corresponding regions can be optimized independently of each other.

For example, a multicolored holographic image with a particularly uniform intensity for different wavelength ranges can be created as a result. Thus, it may be preferable for the polychromatic holographic image to comprise a holographic image in the red color range, which is created by the first region of the holographic structure, and a holographic image with a white hue, which is created by the second region. By setting the powers of the first and second light sources appropriately, it is possible to obtain uniform brightness levels of the red and white image content of the holographic image.

This is not readily possible by means of a light source, for example an RGB LED for illuminating a single holographic structure. Thus, as a rule, this would produce white image content with higher brightness or luminance than the monochromatic image content, for example in the red color range. While virtually the entire spectrum of the RGB LED can be used for creating the white image content in the first case, only the corresponding wavelength ranges of the respective colors can be used for monochromatic image content. In order to avoid this, it would be possible in principle to reduce the efficiency of an RGB hologram in the holographic structure for creating the white image content. Firstly, setting different efficiencies of an RGB hologram and a monochromatic hologram in this way is complex and not always possible with the desired precision. Moreover, such compensation does not represent an energy-efficient and economical solution.

By providing independently controllable light sources and separate hologram regions, such factors can be easily taken into account in order to achieve an optimal brightness distribution and luminance for the observer.

The device according to the invention serves in particular for creating a polychromatic holographic image.

In the context of the invention, the term holographic image refers in particular to an image that is created by the holographic structure and appears for an observer of the device. The holographic image may have, but need not have, seemingly three-dimensional aspects, as are preferably created by holograms. In this case, the created holographic image may comprise an image in a plane or else have an image with an impression of depth. The holographic image may comprise a virtual and/or real image. The holographic image may have an image encompassed within the plane of the output coupling region (preferably referred to as an “in-plane” hologram) and/or an image encompassed partly or completely outside of the output coupling surface. The holographic image may in particular also be considered to be an illumination function that results from the illumination of the holographic structure. In further preferred embodiments, the holographic image may be created on a projection surface. The projection surface may preferably be a transparent surface, a partly transparent surface or a non-transparent surface. The projection surface may preferably have flat and/or curved sections.

The term polychromatic preferably means that the holographic image appears to be multicolored to an observer. The created holographic image therefore preferably comprises at least two different colors or color combinations, for example selected from a group comprising red, green or blue or combinations of the aforementioned colors. By contrast, a monochromatic holographic image would be a holographic image that essentially comprises wavelengths of one color of light. The polychromatic holographic image may preferably also comprise multiple colors, for example three, four, five or more colors. Within the meaning of the invention, a color preferably means light of a certain wavelength range from the visible spectrum (380 nm to 780 nm) with a bandwidth of less than 50 nm, preferably less than 40 nm, less than 30 nm or less, where a maximum or peak is present at a central wavelength characteristic of the color. For example, the central wavelength may be approx. 460 nm for blue light, while green light may have a central wavelength of approx. 530 nm, or red light may have a central wavelength of approx. 625 nm. Within the meaning of the invention, “white” preferably means light with components of at least three or more colors, preferably with components in the blue, green and red ranges. The components of a holographic image of a certain wavelength range or color or color combinations may also be referred to as a color channel within the meaning of the invention. A red color channel consequently preferably means a portion of the holographic image in the red color range, while a white color channel preferably means a portion of the holographic image with a combination of red, blue and green color ranges.

In order to create the polychromatic holographic image, light from the first light source and the second light source is preferably coupled into the light guide. The light guide preferably denotes a component within which light propagates in order to then create the polychromatic holographic image. In particular, light from the first light source and light from the second light source propagates by reflections, preferably total-internal reflections, within or throughout the light guide such that the polychromatic holographic image is created.

Input coupling of light into the light guide preferably denotes the entry of light therein. For this purpose, the light guide comprises a first and a second input coupling region. The first input coupling region is used to input couple light from the first light source into the light guide. Analogously, the second input coupling region is used to input couple light from the second light source into the light guide. By preference, the first light source and the second light source are designed to correspondingly radiate light into the first and the second input coupling region. The input coupling regions are preferably formed as surfaces of the light guide, with these possibly representing partial regions of a common surface or separate, discrete surfaces.

By preference, the input coupling regions are formed such that the input coupling efficiency is e.g. more than 50%, 60%, 70%, 80% or 90%, particularly preferably virtually 100%. In this context, the input coupling efficiency refers to the proportion of light that can be let into the light guide and can be used accordingly for the illumination of the holographic structure. After light from the first and/or second light source has been input coupled or let in, the light propagates in the direction of the holographic structure in order to create the polychromatic holographic image. The propagation for holographic imaging may be direct or include deflections, in particular reflections, for example at deflection regions and/or other holographic structures.

By preference, the holographic structure denotes a structure, the illumination of which enables a reconstruction of a hologram that appears to an observer as a polychromatic holographic image. In particular, the holographic structure denotes a structure in or on which one or more holograms that can be reconstructed as a polychromatic holographic image have been recorded. The holographic structure is preferably present as a holographic-optical element (abbreviated HOE; plural form: HOEs) or as a plurality of HOEs. A HOE preferably refers to a component that was provided by methods of holography and fulfils an optical function.

For example, an optical function can be a transmission, reflection, diffraction, scattering and/or deflection of light. HOEs have proven to be particularly advantageous for use as a holographic structure, as they are cost-effective in production and robust, and so they have a low susceptibility to interference and are therefore also stable for the long term. Furthermore, a HOE can be configured to be particularly flat and thus be particularly space-saving or easily integrated on or in the light guide.

According to the invention, the holographic structure comprises a first region and a second region. In this case, the first region is wavelength-selective for a first wavelength range, which is radiated into the light guide by the first light source. Likewise, the second region is wavelength-selective for a second wavelength range that is radiated into the light guide by the second light source. In particular, wavelength selectivity refers to the fact that a reconstruction of a recorded hologram for the creation of the polychromatic holographic image is only possible virtually exclusively in the wavelength range for which there is selectivity. In other words, the first region of the holographic structure should bring about a reconstruction only for light with a wavelength within the first wavelength range. By contrast, no holographic image is created when the first region of the holographic structure is illuminated with light at a wavelength outside the first wavelength range. The diffraction conditions are preferably satisfied by the hologram only for light in a first wavelength range. Light of other wavelengths is preferably not diffracted by the first region of the holographic structure.

A corresponding statement also applies to a wavelength selectivity of the second region of the holographic structure, according to which a reconstruction should be made selectively for light of a wavelength in the second wavelength range.

According to the invention, the first and second wavelength ranges are not identical. In preferred embodiments, the first and second wavelength ranges may represent disjoint ranges and substantially have no intersections. For example, this may be the case inasmuch as the first and second wavelength ranges correspond to different colors. For example, a first wavelength range may correspond to one color (e.g. blue, red or green), while the second wavelength range corresponds to another color.

However, intersections existing between the first wavelength range and the second wavelength range may likewise also be preferred. For example, the second wavelength range may be completely encompassed by the first wavelength range, or vice versa. Thus, in preferred embodiments, the first or second wavelength range may correspond to a white spectrum and have components in the blue, green or red color spectrum, while the other second or first wavelength range is monochromatically assigned to one color, e.g. blue, green or red.

The first and second wavelength ranges will not be identical in these embodiments either, and so the first wavelength range encompasses wavelengths not encompassed by the second wavelength range, or vice versa.

The first region and the second region of the holographic structure preferably refer to different surface sections of the holographic structure. The holographic structure is preferably flat, with a length or width of the holographic structure being significantly greater than a height or thickness, preferably by a factor of 10, 100, 1000 or more. While characteristic dimensions of the holographic structure are preferably in the order of centimeters (1 cm to 100 cm), the thickness or height is typically in the order of micrometers (1 μm to 1000 μm).

The first region and the second region of the holographic structure preferably identify partial surfaces of the holographic structure, with it possibly being preferable for the sum of the first region and the second region to span the entire surface of the holographic structure. For example, the holographic structure may be formed by two adjacent HOEs, which correspond to the respective regions. Likewise, the sum of the first region and the second region of the holographic structure may form a partial surface of the holographic structure, with a non-negligible surface of the holographic structure being assigned neither to the first nor to the second region. It is also possible for the holographic structure to be subdivided into three or more regions in preferred forms, with preferably three or more light sources being provided for illumination of the corresponding regions.

The first and second regions are not limited to one shape. The first and second regions may have substantially the same or different shapes. The first and/or second region may for example have round shapes, for instance circular and/or elliptical shapes, and/or angular shapes, such as triangular, square, pentagonal, hexagonal and/or other polygonal shapes. Free forms for the first and/or second regions, which are adapted to the optical image content to be displayed, are also conceivable.

Terms such as “substantially”, “approximately”, “about”, “approx.”, etc. preferably describe a tolerance range of less than ±40%, preferably less than ±20%, particularly preferably less than ±10%, even more preferably less than ±5%, and in particular less than ±1%, and always include the exact value.

In a further preferred embodiment, the device is characterized in that a surface of the light guide forms an output coupling surface, wherein the holographic structure is preferably arranged substantially parallel to the output coupling surface and is configured to output couple light of the first wavelength range via a first output coupling region of the output coupling surface under illumination of the first region and to output couple light of the second wavelength range via a second output coupling region of the output coupling surface under illumination of the second region, in order to create the polychromatic holographic image.

In the context of the invention, the output coupling surface should preferably be understood to be a structural section of the light guide. By preference, the output coupling surface comprises an interface of the light guide, which closes off the light guide outwardly. In particular, the output coupling surface may form an interface, by means of which the polychromatic holographic image is created. Preferably, the light from the first light source and the light from the second light source are illuminated with the holographic structure in order to be output coupled from the light guide through the output coupling surface. In particular, the holographic structure may be present within or below the output coupling surface of the light guide. By preference, the holographic structure is arranged adjacent to the output coupling surface and arranged substantially parallel to same, with adjacent meaning a distance of less than 1 mm or less. However, it may also be preferable for the holographic structure to be arranged at a significantly greater distance from the light guide, with the light for generating a holographic image passing through a partial region of the light guide following an illumination by the light source.

Furthermore, it is preferable for the output coupling surface to have a subdivision into a first output coupling region and a second output coupling region. The first and second output coupling regions preferably correspond to the first and second regions of the holographic structure, wherein the first output coupling region is preferably designed to be congruent with the first region of the holographic structure, and the second output coupling region is preferably designed to be congruent with the second region of the holographic structure.

The output coupling of light from the first light source is implemented via the first output coupling region, said output coupled light creating a portion of the holographic image on the basis of an illumination of the first region of the holographic structure. The output coupling of light from the second light source is implemented via the second output coupling region, said output coupled light being guided to the second region of the holographic structure, as described.

The preferred substantially parallel arrangement of the holographic structure with respect to the output coupling surface preferably means that a surface normal of the output coupling surface also forms a surface normal of the arrangement plane of the holographic structure. By preference, the holographic structure is consequently arranged substantially perpendicular to the surface normal of the output coupling surface. A person skilled in the art knows that parallelism may relate not only to plane but also to curved surfaces. In particular, curved surfaces are parallel provided that they are curved in the same way and do not intersect or would not intersect if they were enlarged to any desired extent or would only intersect at infinity. In the case of a curved arrangement plane of the holographic structure, the surface normal preferably is a surface normal of the tangential plane at the geometric centroid of the arrangement plane.

In a further preferred embodiment, the device is characterized in that the first region and the second region of the holographic structure have no overlap region or an overlap region of less than 30%, preferably less than 20%, 10%, 5% or less, wherein the overlap region preferably relates to an overall area of the holographic structure.

An overlap region preferably means an intersection of the first region and second region of the holographic structure, and so the complete lack of an overlap region marks a spatial separation of the first region and the second region without the slightest overlap. In particular, in the context of this embodiment, it may be preferable for the first region and the second region to be present directly adjacent to each other. Directly close-fitting may therefore preferably mean that the first and second regions are in contact, but there is no overlap region.

However, it may also be preferable for an overlap region to be present, with the latter being significantly smaller in relation to a total area of the holographic structure. By preference, the overlap region has an area of less than 30%, preferably less than 20%, less than 10%, less than 5% or less. Consequently, even if the first and second regions have an intersection (overlap region), the latter is consequently always much smaller than a union of the two regions (overall area of the holographic structure). The advantages of the invention with regard to a particularly pronounced separation of the color channels for a first and a second region apply in particular to regions outside of the overlap region. Nevertheless, in embodiments it may be preferable for an overlap region to be provided, for example provided that image content less sensitive to possible crosstalk of different color channels should be displayed in the border region.

In a further preferred embodiment, the device is characterized in that the first region and the second region of the holographic structure are separated from each other by a separation region, wherein the separation region has a lateral extent of at least 1 mm, preferably at least 2 mm, at least 5 mm or more.

The lateral extent relates in particular to a distance along an arrangement plane of the holographic structure on or in the light guide. Should the holographic structure be curved, the lateral extent preferably refers to a plane that passes through a geometric centroid of the holographic structure and is arranged substantially parallel to the output coupling surface. The preferred separation regions make it particularly easy to ensure that the first and second light source only illuminate their respectively assigned regions and not an unassigned region as well. Crosstalk or color smears are avoided particularly reliably.

In a preferred embodiment, the light source emits a coherent light beam. Coherence preferably refers to the property of optical waves whereby there is a fixed phase relationship between two wave trains. Spatially stable interference patterns may arise as a result of the fixed phase relationship between the two wave trains. With regard to coherence, a distinction can be made between temporal and spatial coherence. Spatial coherence preferably represents a measure for a fixed phase relationship between wave trains perpendicular to the propagation direction and is for example given for parallel light beams which have a plane wavefront. Temporal coherence preferably represents a fixed phase relationship between wave trains along the propagation direction and is given in particular for narrowband, preferably monochromatic light beams.

The coherence length preferably denotes a maximum path length difference or time-of-flight difference that two light beams from a starting point have, so that a (spatially and temporally) stable interference pattern arises during their superposition. The coherence time preferably refers to the time that the light needs to travel a coherence length.

Consequently, narrowband light sources, preferably monochromatic light sources, including lasers and/or light-emitting diodes (LEDs), for example, are preferred.

In a preferred embodiment, the device is characterized in that the first light source and/or the second light source is a laser and/or an LED, wherein by particular preference the first light source is an RGB LED, and the second light source is a monochromatic LED.

By preference, the LED as first and/or second light source comprises a multicolored emission spectrum. An RGB LED preferably refers to an LED that comprises one or more emitters for the colors R (red), G (green) and B (blue). The one or more emitters may preferably be controlled on an individual basis. For example, an Osram MULTILED LRTB GVSG, which emits at 625 nm (red), 528 nm (true green), 460 nm (blue), may be used as RGB LED. For example, intensities may be 500-1000 millicandela (mcd) for red, 1250-2010 mcd for green and 180-560 mcd for blue.

A monochromatic LED refers to an LED comprising one or more emitters that can emit light of one color within a wavelength range. For example, this may also be a wavelength range that is used to emit light in R, G or B.

The combination of an RGB LED as first light source and a monochromatic LED as second light source has proven to be particularly advantageous in relation to the creation of a polychromatic holographic image. A particularly compact structure of the device can advantageously also be ensured in addition to the advantageous avoidance of crosstalk between the various light channels, which is relevant to the beam path of the light from the different light sources.

The use of lasers is advantageous in that the light emitted by a laser has a particularly pronounced coherence, whereby a particularly high quality of the holographic images can be achieved. However, in comparison with LEDs, lasers are usually more expensive. By preference, semiconductor lasers or laser diodes, for example, can be used.

In a further preferred embodiment, the device is characterized in that the first and/or second light source is designed to emit light with a wavelength between 380 and 780 nm.

In a preferred embodiment, the first light source is a polychromatic light source. By preference, in the first wavelength range, the first light source emits light of a spectrum with a width of at least 100 nm, preferably at least 200 nm, at least 300 nm or more.

In preferred embodiments, the second light source is a monochromatic light source. By preference, in the second wavelength range, the second light source emits monochromatic light with a bandwidth of less than 50 nm, preferably less than 40 nm or less than 30 nm.

The bandwidth of the monochromatic light preferably corresponds to a full width at half-maximum, at which a light emission has dropped to half a maximum and which is abbreviated FWHM.

Based on the definition of a bandwidth of monochromatic light sources using the FWHM, the width of the spectrum of a polychromatic light source is defined in such a way in the present case that it corresponds to a difference between a longest wavelength that still has 50% of a global maximum and a shortest wavelength that still has 50% of the intensity of a global maximum. In the case of a monochromatic light source with one peak, the width of a spectrum will correspond to an FWHM bandwidth. In the case of a polychromatic light source, the width of the spectrum according to the above definitions approximately corresponds to the FWHM of an enveloping spectrum, which, as explained below, may also be discontinuous in preferred variants and has a plurality of (separate) spectral regions or peaks.

In some embodiments, the spectrum of the polychromatic first light source may be of a continuous nature, i.e. preferably have a substantially continuous curve over the first wavelength range. In this case, continuous is taken to mean the absence of pronounced emission peaks in particular. For example, a continuous spectrum is given for what are known as pseudo-white LEDs, which are based on an excitation of fluorescent phosphor. In most cases, ultraviolet or blue-emitting LEDs are coated with a yellow or multichromatic fluorescent phosphor. The phosphor forms a conversion layer, which may be excited by the higher-frequency photons of the ultraviolet or blue LED to radiate a yellowish-white light. By selecting the phosphor and/or LEDs, different white tones with color temperatures between 2500 kelvins and 10 000 kelvins can be defined.

While such continuous spectra allow a particularly nuanced setting of a white hue from warm white (ww), neutral white (nw) to cold white (cw), the radiation usually has only a short coherence length, and this may adversely affect the quality of the holographic image. In addition, this would require a hologram designed for a wide bandwidth, or efficient diffraction would only be possible for a significantly smaller component of the light.

In preferred embodiments, the polychromatic spectrum of the second light source is therefore designed to be discontinuous and may comprise a plurality of preferably separate spectral regions. For example, this may be an RGB laser or an RGB LED in this case. In contrast to a pseudo-white LED, an RGB LED generates a white hue by a superposition of light with the colors of red (R), green (G) and blue (B), the latter preferably being created by corresponding monochromatic LEDs for the respective colors.

Consequently, the spectrum of an RGB LED comprises three spectral ranges, which cover the wavelengths for the colors R, G and B. As explained above, within the meaning of the invention, a color preferably means light of a certain wavelength range from the visible spectrum (380 nm to 780 nm) with a bandwidth of less than 50 nm, preferably less than 40 nm, less than 30 nm or less, where a maximum or peak of the emission spectrum is present at a central wavelength characteristic of the color. For the color red, the central wavelength is preferably in a wavelength range of 610 nm-760 nm, preferably at approx. 625 nm, for G (green) it is in a wavelength range of 500 nm-570 nm, preferably at approx. 530 nm, and for blue it is in a wavelength range of 450 nm-500 nm, preferably at approx. 460 nm.

For an RGB laser, there are preferably also three spectral ranges for the colors R, G and B present in analogous fashion, with the lasers for the respective colors preferably being of significantly narrower bandwidth in comparison with the corresponding LEDs.

The bandwidths (FWHM) of monochromatic LEDs are preferably 5 nm to 50 nm, preferably between 10 nm and 40 nm, particularly preferably approx. 20 nm to approx. 30 nm.

The bandwidths (FWHM) of monochromatic lasers, for example of laser diodes, by contrast are preferably less than 4 nm, preferably less than 2 nm, less than 1 nm or less.

By using an RGB LED or an RGB laser, a white hue may advantageously be conveyed for corresponding image content of a holographic image without needing to make significant compromises with regard to the coherence of the illumination radiation. In comparison with continuous white light sources, the discontinuous spectrum of an RGB LED or an RGB laser is characterized by the superposition of three narrowband spectral ranges.

The preferred specifications in relation to the light sources and wavelength ranges have proven to be particularly advantageous in the context of the invention, in order to obtain a holographic image that is capable of displaying image content of different hues particularly sharply and plastically.

Appropriate light sources capable of emitting light in the aforementioned bandwidths and/or wavelength ranges may be arranged in relation to an illumination of the holographic structure.

In a further preferred embodiment, the device is characterized in that the light guide is formed by a monolithic substrate, wherein the substrate preferably comprises a material which is an optical plastic, preferably selected from a group comprising polymethylmethacrylate (PMMA), polycarbonate (PC), cycloolefin polymers (COP), cycloolefin copolymers (COC), and/or an optical glass, preferably selected from a group comprising borosilicate glass, B270, N-BK7, N-SF2, P-SF68, P-SK57Q1, P-SK58A, P-BK7, N-FK5, N-PK51, P-SK57, P-LAK35, P-LASF47, N-KZFS11, P-SF69 or SF57.

In this case, monolithic preferably means consisting of one piece or integral. In this case, monolithic may mean manufactured from one piece (e.g. the raw material or substrate) in particular.

These materials are distinguished by good optical properties for holography and are also suitable for industrial scale manufacturing. They advantageously allow cost-efficient series production with an unchanging, highest optical quality. In addition, a wide range of geometrical and complex geometries can be made possible by means of appropriate processing.

By preference, the material of the substrate, for example an optical plastic or an optical glass, has a refractive index of between 1.4 and 1.9, preferably between 1.4 and 1.6.

With regard to optical glass, it is moreover preferable for the optical glasses to have a low transition temperature (so-called low T_{g} glass), which is particularly suitable for blank pressing and/or precision blank pressing. As a result, complex and/or microstructured shapes for the light guide can be realized by a single process step, and so the use of the preferred optical glasses is particularly advantageous for the provision of the light guide. Furthermore, the light guide can be shaped so precisely that a targeted and uniform illumination of the holographic structure is rendered possible, and this is advantageous for the reconstruction of the polychromatic holographic image.

In a preferred embodiment, the device is characterized in that an output coupling surface of the light guide is arranged substantially parallel to opposing input coupling regions of the light guide. In preferred embodiments, the input coupling regions may represent partial regions of a continuous input coupling surface of the light guide. In the embodiment, the output coupling surface and input coupling surface are preferably opposite one another as parallel interfaces of the light guide. The light guide may have side faces that, as described below, serve to deflect the light to the output coupling surface. This allows a particularly compact trapezoidal shape of a light guide to be realized, the outer surfaces of which may also be provided in a simple way with high precision.

A substantially parallel arrangement of the output coupling surface to an input coupling surface or to input coupling regions preferably means that surface normals of the output coupling surface and input coupling surface or of the input coupling regions coincide with each other and/or extend substantially parallel to each other. As explained above, the parallelism may relate to not only plane but also curved surfaces, which are curved in the same way and do not intersect or would not intersect if they were enlarged to any desired extent or would only intersect at infinity.

The light sources are preferably arranged spaced apart from the input coupling regions such that light, preferably collimated by a further optical component, is incident on the respective input coupling regions in substantially perpendicular fashion.

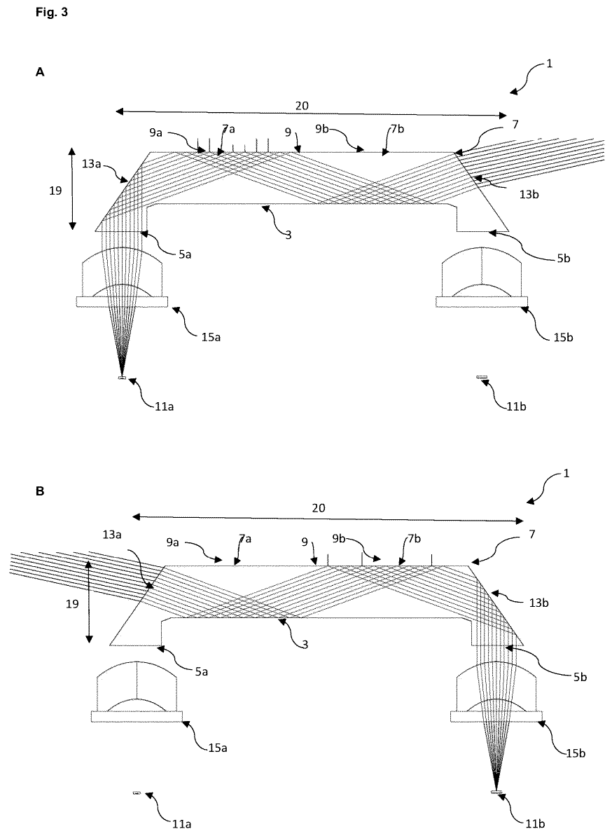

The input or output coupling surface may preferably be provided as a contiguous surface. However, it may also be preferable for the input and/or output coupling regions to be present on a discontinuous outer surface of the light guide. For example, it might be preferable for the first and second input coupling regions to be arranged in a plane parallelly opposite to an output coupling surface, but with the outer surface of the light guide between the input coupling regions not extending continuously but having a recess. For example, the recess may serve to reduce material provided that no guidance of the light is necessary in the recessed, central region (see FIG. 3). The output coupling surface may likewise be interrupted. For example, provided that a separation region is present between a first and a second region of the hologram structure, it may be preferable for the output coupling surface to not extend continuously over the separation region but for the corresponding output coupling regions to be present in a plane but on separate surfaces.

In an embodiment, it may also be preferable for an output coupling surface of the light guide to be arranged substantially perpendicular to the first input coupling region and to the second input coupling region. For example, the input coupling regions may be arranged in the direction of an interior of the light guide, wherein they preferably are arranged in such a way that they laterally enclose a partly open inner region of the light guide in at least regions. In that case, the light sources may preferably be arranged in the partly open inner region of the light guide and preferably radiate on the respective input coupling regions in perpendicular fashion, wherein a deflection of the light to the respective regions of the holographic structure is implemented by way of appropriate deflection regions, preferably on outer side faces of the light guide.

The preferred device thus advantageously allows a variation with regard to the positioning of the input coupling regions, the output coupling surface and light source, and so these may be optimized depending on the available installation space.

In a further preferred embodiment, the device is characterized in that the light guide is configured to guide light in the direction of an output coupling surface of the light guide at an angle of incidence that is greater than a critical angle for total-internal reflection and/or within an absolute value range between 50° and 80°, preferably between 60° and 75°.

Within the meaning of the invention, the angle of incidence refers in particular to the angle formed between the radiation incident on the output coupling surface and a surface normal of the output coupling surface (see FIGS. 1, 2). Unless otherwise specified, angle statements refer to an absolute value of the angle of incidence.

A first angle of incidence is preferably present between the incident radiation from the first light source and the surface normal of the output coupling surface. A second angle of incidence refers accordingly to the angle between the incident radiation from the second light source and the surface normal of the output coupling surface. For the contribution of the first and second angle of incidence, the above ranges are equally preferred.

However, in relation to an (azimuthal) direction from which light is guided to the output coupling surface, the angle of incidence may also be assigned a sign in preferred forms. In preferred embodiments, the light from the first light source is guided within the light guide to the first region from an opposite direction to the output coupling surface in comparison with the light from the second light source.

In such an illumination of the holographic structure from opposite directions, azimuthal angles of the incident light from the respective light source differ by approx. 180°, with respect to a surface normal of the output coupling surface.

In the context of the invention, the intention is to define that, in the embodiment, light from the first light sources is incident on the first region at an azimuthal angle of 0°, with the angle of incidence being counted positively as the polar angle with the surface normal. Light from the second light source, which is radiated on the second region from an opposite direction at an azimuthal angle of 180°, by contrast, is radiated on the second region at a negative angle of incidence.

In preferred embodiments, the first and second angles of incidence are substantially equal in terms of absolute angle.

By illuminating the output coupling surface at an angle of incidence which in terms of absolute angle is greater than a critical angle for total-internal reflection, it is advantageously possible to suppress output coupling of the zeroth order from the output coupling surface. The zeroth order is undesirable as it comprises none of the information stored in the holographic structure and potentially dazzles the observer. Depending on the effectiveness of the holographic structure, substantial components of the incident light cannot be diffracted but can be transmitted or reflected by the hologram as zeroth order. The aforementioned preferred angular ranges reliably ensure a suppression of zeroth order output coupling, in particular for light guides with a refractive index between 1.4 and 1.7, the output coupling surface of which borders on air.

At the same time, the absolute value ranges for the angles of incidence have proven to be particularly advantageous in relation to the reconstruction of the polychromatic holographic image. In contrast with larger (flatter) angles of incidence, particularly high diffraction efficiencies by the holographic structure and a plastic impression of the holographic image could be achieved.

In particular, the aforementioned angles of incidence allow a reliable diffraction of the light by the holographic structure into a first order, which is particularly relevant for the reconstruction of the one or more holograms of the holographic structure for the polychromatic holographic image.

In another preferred embodiment, the device is characterized in that the light guide comprises a first deflection region for deflecting the input coupled light from the first light source to the first region of the holographic structure and a second deflection region for deflecting the input coupled light from the second light source to the second region of the holographic structure.

The deflection region preferably refers to a region situated on or within the light guide and designed to steer input coupled light in the direction of the holographic structure for the purpose of creating the polychromatic holographic image. By preference, the light guide comprises a first and a second deflection region, wherein the light from the first light source is steered to the first region by the first deflection region, and the light from the second light source is steered to the second region of the holographic structure by the second deflection region. A targeted guidance of the radiation in the direction of the first and/or second region can be advantageously achieved by the deflection regions, whereby a possible influence of different color channels within the light guide is further reduced.

In a further preferred embodiment, the device is characterized in that the first and/or second deflection region is a reflection surface, wherein the reflection surface is preferably arranged at an interface of the light guide and particularly preferably causes a deflection of the light by way of a reflective coating or total-internal reflection at the interface.

A reflection surface is preferably a surface within the light guide that is capable of substantially reflecting the light beams from the first and/or second light source. In particular, this means that it substantially reflects the rays at the respective angle of reflection and/or in the respective frequency spectrum. This may preferably mean a reflection of at least 50% of the light incident on the reflection surface, preferably at least 60%, particularly preferably at least 70%, and very particularly preferably at least 80% or more. By preference, the reflection is substantially specular reflection as opposed to diffuse reflection. It may also be preferable for a proportion of diffuse reflection to take place in addition to the specular reflection, in order to achieve homogenization of the light.

The reflection surface may preferably be a flat surface. However, this may also be a curved surface for the beam shaping of the input coupled light. The reflection surface preferably has a surface normal at its centroid, in particular of a tangential plane of the reflection surface through its centroid, which intersects the surface normal of the output coupling surface, for example at an angle between 10° and 80°, preferably between 20° and 70°.

By preference, a first reflection surface and a second reflection surface are present, wherein the first reflection surface is designed for the reflection of light from the first light source, and the second reflection surface is designed for the reflection of light from the second light sources. The reflection may preferably be based on a total-internal reflection on account of a change in the refractive index at the reflection surface from a higher to a lower refractive index and/or on account of the material properties of the reflection surface, which has a high reflectance for the frequency spectrum of the light source. By way of example, such a reflectance can be obtained by an appropriate coating, e.g. with a metal such as aluminum, silver, and/or gold.

The reflection surface is preferably configured for direct reflective illumination of the holographic structure by input coupled light. This preferably means that the reflection surface is arranged and/or designed in such a way that the light input coupled into the light guide is preferably reflected directly (i.e. without deflection) from the input coupling surface to the reflection surface and, from there, to the holographic structure. For example, light from the first light source may be input coupled into the light guide via the first input coupling region, be guided to the first reflection surface and subsequently be reflected to the first region of the holographic structure. Accordingly, light from the second light source, for example, may be input coupled into the light guide via the second input coupling region, be guided to the second reflection surface and subsequently be reflected to the second region of the holographic structure.

In a preferred embodiment, the light from the first light source and/or the second light source is deflected directly to the first region and/or the second region by the first deflection region and/or second deflection region, preferably without further reflections and/or transmissions within the light guide. This allows particularly lossless propagation and efficient illumination of the holographic structure.

Advantageously, the use of two reflection surfaces, which guide the light directly to the respective regions of the holographic structure, allows a particularly advantageous beam path to be achieved, the latter ensuring a compact design, high light yield and a sufficient course within the light guide in order to ensure controlled shaping in accordance with the requirements of the holographic structure.

In embodiments, the reflective illumination via the first and/or second reflection surface may also not be implemented along a direct route; instead, further structures, for instance reflection surfaces and/or HOEs, may be provided to guide the light from the first light source to the first region and the light from the second light source to the second region of the holographic structure.

In a preferred embodiment, the device is characterized in that the first and second input coupling regions, and preferably also a first and a second deflection region, are arranged substantially mirror symmetrically with respect to a plane of symmetry that is orthogonal to an output coupling surface. Particularly preferably, the entire light guide and also the light sources or possible optical components for beam shaping may also be arranged substantially mirror symmetrically with respect to the plane of symmetry. The plane of symmetry is preferably substantially centered on the output coupling surface and runs along the depth of the device.

In a two-dimensional cross section of the device (see FIGS. 1-3), a mirror-symmetrical arrangement of the components with respect to a surface normal of the output coupling surface is preferably present. The surface normal in this case preferably corresponds to a central perpendicular on the output coupling surface.

By preference, such a mirror-symmetrical arrangement can ensure that the angles of incidence between light beams from the first light source and from the second light source are substantially identical in terms of absolute value but have different signs.

In an embodiment, the device is characterized in that the light guide is configured to guide light of the first wavelength range onto the first region of the holographic structure at a first angle of incidence in the direction of an output coupling surface of the light guide and guide light of the second wavelength range onto the second region of the holographic structure at a second angle of incidence, wherein the light of the first and second wavelength ranges is guided from substantially opposite directions to the output coupling surface such that preferably the first and second angles of incidence are substantially the same in terms of absolute value but have different signs.

The mirror symmetry preferably also covers minor asymmetries, for example deviations of less than 10%, preferably less than 5% or less. Likewise, the guidance of the light from opposite directions should preferably also cover directions which have an azimuthal angle of 180°+/−20° or less, preferably 180°+/−10° or less.

In preferred embodiments, in a mirror-symmetrical arrangement, the light guide is designed as a symmetrical isosceles trapezoid, wherein, in cross section, the input coupling regions are present on a longer base side of the trapezoid and the shorter, parallel base side forms an output coupling surface. The sides of the trapezoid represent the deflection regions of the light guide.

In preferred embodiments, a first deflection region and/or second deflection region, or corresponding outer sides of the light guide on which the first and/or second deflection region are present, make an obtuse angle of 130° to 170°, preferably 145° to 165°, with an output coupling surface, whereby preferably corresponding angles of incidence of 50° to 80°, particularly preferably 45° to 75°, are ensured.

Crosstalk is additionally avoided by illuminating the two regions of the holographic structure at angles of incidence with the same absolute value but different signs. Even in the event that, for example, stray light from the first light source is guided onto the second region in part, the different angle selectivities of the first and second regions (in addition to preferred different wavelength selectivities) ensure a clear separation of the color channels.

Advantageously, a particularly homogeneous illumination of the first and second regions of the holographic structure can be achieved by a mirror-symmetrical arrangement, independently of whether the first and the second regions are arranged in directly close-fitting fashion, spaced apart fashion and/or overlapping fashion with an overlap region. In addition, the mirror-symmetrical arrangement is characterized by a particularly compact design and low installation depth. As explained above, what may be advantageously exploited here is the fact that by using two light sources and separate regions of the holographic structure, a small beam cross section is required for ensuring effective illumination. In comparison with a variant having only one light source, for example, it is possible to design the deflection surface to be significantly smaller, and an extent of the light guide in the axial direction (height) can be minimized, i.e. in a direction parallel to the axis of symmetry or to the surface normal of the output coupling surface.

As a result of the achievable low installation space depth in combination with a robust structure, which can be implemented cost-effectively with high precision, this embodiment is particularly suitable for applications in the context of vehicles, for example in the automotive industry.

In a preferred embodiment, the device is characterized in that a height of the light guide is 10 mm to 50 mm, preferably 20 mm to 30 mm, a width of the light guide is 40 mm to 200 mm, preferably 70 mm to 150 mm, and/or a depth of the light guide is 20 to 120 mm, preferably 30 to 80 mm.

The height preferably denotes a maximum extent of the light guide in the direction of a surface normal of the output coupling surface, which may form an axis of symmetry in cross section in the case of a mirror-symmetric alignment. A width of the light guide preferably denotes a maximum extent of the light guide in a direction along the plane of the output coupling surface, preferably along that azimuthal direction along which the light from the first and second light sources is guided to the output coupling surface. The depth of the light guide preferably denotes a maximum extent of the light guide in a direction along the plane of the output coupling surface orthogonal to the width.

The aforementioned dimensions for the light guide have proven to be advantageous in order to enable sufficient compactness and thus allow use in versatile installation purposes.

By preference, the further components for collimating the light, such as light sources or optical components, may be arranged extremely compactly within the device (see, inter alia, the arrangement of FIG. 2).

In a preferred embodiment, the device has a height of 40 mm to 100 mm, preferably 60 mm to 80 mm, a width of 100 mm to 200 mm, preferably 120 mm to 150 mm, and/or a depth of 30 to 120 mm, preferably 30 to 80 mm.

In another preferred embodiment, the device is characterized in that the holographic structure is in the form of a volume hologram.

By preference, a volume hologram denotes a hologram that was recorded in a light-sensitive, comparatively thick layer. By preference, this may be implemented by transmission or reflection technology. A sequence of Bragg planes preferably arises as a result of the interference of object and reference beam within the hologram volume. A volume hologram may therefore also be considered to be a holographic grating, i.e. an optical grating produced by holography methods. Consequently, a volume hologram preferably has a non-negligible extent in the propagation direction of the light beams, with the Bragg condition applying in the case of a reconstruction at a volume hologram. For this reason, volume holograms advantageously have a wavelength and/or angle selectivity, and so they are particularly suitable for use as a holographic structure for the context of the invention. The capability of volume holograms to store a plurality of images at the same time moreover allows the production of polychromatic holograms.

Light sources emitting in the three basic colors of blue, green and/or red may be used for the recording of polychromatic holograms. Following exposure, one, two, or three holograms are stored in the volume hologram at the same time, depending on the exposure. The reproduction of the color hologram may exploit the fact that each partial hologram may only be reconstructed by the color with which it was recorded. Consequently, the three reconstructed color sectors are superimposed to form the colored, faithful image, provided that the color components are weighted correctly.

In another preferred embodiment, the device is characterized in that the holographic structure is a transmissive holographic structure or a reflective holographic structure.

A transmissive holographic structure may also be referred to as a transmission hologram. Analogously, a reflective holographic structure may also be referred to as a reflection hologram.

Reflection holograms are reflective holograms which reflect the light incident from the first and/or second light source and consequently act like a mirror. Advantageously, reflection holograms have a high wavelength selectivity and angle selectivity. This means that a reflection hologram only efficiently diffracts a certain wavelength or a narrow wavelength range at a preferred angle. Chromatic aberrations are avoided or significantly reduced in this way. Reflection holograms are therefore particularly suitable for the creation of polychromatic holographic images.

Transmission holograms are transmissive holograms, wherein the light from a light source is passed and diffracted by the latter.

By preference, the holographic structure may be connected to a surface of the light guide. For example, the connection may be made possible by adhesive bonding and/or lamination. In addition, it is preferable for the holographic structure in the form of one film or in the form of two or more films to be connected to the substrate. For example, the first and second region of the holographic structure may be present on a film or on separate films that are connected to a surface of the light guide. For example, the film might also be connected to the substrate only in the region of an output coupling region. In alternative embodiments, a connection between the holographic structure in the form of at least one film and the light guide may be formed substantially over the entire area.

In preferred embodiments, the device may for example comprise a transparent upper cover that serves to protect the holographic structure and is present between the cover and the light guide preferably in the form of a monolithic substrate. By preference, the upper cover has a refractive index that is chosen such that light is passed through said upper cover, the holographic structure and the light guide. The upper cover may be for example a transparent film or a glass layer. By preference, the materials of the light guide, the holographic structure and the cover are selected such that the refractive index differences between the individual layers are small. This allows internal reflections to be avoided.

When reconstructing a reflection hologram, for example, light is guided by the transparent light guide to the reflection hologram, preferably by a deflection region, as described. The light passes through the reflection hologram and is reflected back to the reflection hologram off an upper interface of the cover. In preferred forms, this may be implemented by a total-internal reflection at the interface. The angle at which the rays of light subjected to total-internal reflection meet the reflection hologram is crucial for its reconstruction and corresponds directly to the angle of incidence of the light on the output coupling surface formed by the cover. The light subjected to total-internal reflection is substantially reflected by the reflection hologram into a first order, which is preferably designed for a direction of the eyebox. The illumination may also be referred to as edge-lit since in this case reconstruction is in essence performed from the medium of the light guide, wherein an angle of incidence is greater than an angle of total-internal reflection at the interface of the light guide to the surroundings.

When reconstructing a transmission hologram, light is guided by the transparent light guide to the transmission hologram, preferably by a deflection region, as described. The light passes through the transmission hologram and is substantially diffracted into a first order preferably aligned substantially orthogonal to the surface of the transmission hologram.

In preferred embodiments, the first and second regions of the holographic structures, which are used for the reconstruction of the polychromatic holographic image, may be present in different films. It may also be preferable for the first and second regions of the holographic structures to be arranged in a single film, for example in a hologram film in which they were exposed together.

In preferred forms, a polychromatic holographic image can be achieved by virtue of the first and second regions of the holographic structure creating holographic images of different colors and/or color combinations.

Preferably, each region of the holographic structure may be assigned to a color channel, and so the associated color or color combination can be used to create the polychromatic holographic image by illuminating the corresponding region of the holographic structure.

The holographic structure preferably comprises one or more holograms, which are each assigned to a color channel and can be reconstructed in the totality thereof as a polychromatic holographic image.

By preference, a plurality of holograms may be arranged one above the other, in particular stacked on top of each other, at least in regions in the holographic structure, this being referred to as a so-called stack.

For example, it may be preferable for a stack of a plurality of holograms, for example three holograms, to be present in a first and/or second region of the holographic structure, each of the holograms being wavelength-selective for a respective one of the colors red, green and blue. By preference, such a stack may also be referred to as an RGB stack.

In preferred embodiments, a first and/or second region may also be an RGB stack which, as described and for example using an RGB LED or an RGB laser, can be used to create white image content of a holographic image.

By preference, the stacked holograms arranged one above the other are present in different layers of a film, wherein these have been inscribed, for example, by successive replication of a corresponding RGB master hologram in different light-sensitive layers. It may likewise be preferable to inscribe a plurality of holograms into a single light-sensitive layer in order to create a multiplex hologram.

By preference, one of the two regions of the holographic structure may be present as an RGB stack or multiplex hologram, while the other region is a monochrome hologram. In this context, it may be preferable to provide the first and second regions as different HOEs on different films. However, it may also be preferable to provide a common film, preferably a three-layer film, wherein an RGB hologram has been inscribed in three light-sensitive layers in one region, while a hologram has only been inscribed in one of the light-sensitive layers in the other region.

In a further preferred embodiment, the device is characterized in that an optical component is arranged between the first light source and/or second light source and the light guide, wherein the optical component is configured to reduce a divergence of the light, wherein the optical component is preferably selected from a group comprising a lens element, a mirror and/or a diffractive structure.

Divergence refers to the phenomenon that light beams may propagate in different directions from a center, in particular from the light source, with an angular distribution in relation to a chief ray direction. The optical component between the first and/or second light source and the light guide allows collimation of the light beams such that they are guided in bundled fashion, in particular in a manner extending substantially parallel to one another, with an approximately planar wavefront to the input coupling surface of the light guide and from there to the output coupling surface. Collimation by means of the optical component is preferably brought about in all directions perpendicular to the chief ray direction. In this way, the output coupling surface can be illuminated by a ray or a beam with a small angle spectrum, and the optical quality of the holographic image can be increased.

In this case, the light source can preferably be approximated as a point light source, whereby the collimation is improved, since the collimation of a beam is best when the deviation of the beam origin from the focal point is as small as possible. In this case, it is preferable for the light source and the assigned optical component to be spaced apart by a distance that is configured so that the light source can be approximated by a point light source.

For example, such an approximation may be justified if the emitter surface of the light source has an extent of up to 1×1 mm², and the light source and the optical component assigned thereto have a spacing of at least 15 mm, preferably approx. 20 mm. This allows the collimation of the input coupled light to be further improved without greatly increasing the installation depth.

By preference, a respective optical component is provided for the first light source and the second light source, wherein a distance of the optical component from the light source may be optimized in relation to its wavelength range.

In a further preferred embodiment, the device is characterized in that a first optical component is arranged between the first light source and the light guide, and a second optical component is arranged between the second light source and the light guide, wherein the distances between the first light source and the light guide and between the second light source and the light guide have been independently optimized with respect to a collimation of the light of the respective light sources.

Advantageously, structurally identical optical components may be used for the first and second light sources, for example structurally identical lens elements, which advantageously reduces the effort of producing the device. Nevertheless, sufficient collimation may be achieved by appropriately optimizing the distances of the optical component to the respective wavelength range of the assigned light source.

In a further aspect, the invention relates to a light guide for a device according to the invention for creating a polychromatic holographic image, wherein the light guide comprises a first input coupling region and a second input coupling region for input coupling light, and a holographic structure for creating the polychromatic holographic image, and wherein furthermore the holographic structure has a first region, which is wavelength-selective for light of a first wavelength range, and a second region, which is wavelength-selective for light of a second wavelength range, and wherein the light guide is configured to guide light which is radiated into the first input coupling region to the first region of the holographic structure and light which is radiated into the second input coupling region to the second region of the holographic structure. A person of average skill in the art recognizes that advantages, definitions and embodiments of the device according to the invention also apply to the light guide according to the invention for use in such a device, and vice versa.

In a further aspect, the invention relates to a vehicle seat comprising a device according to a preferred embodiment, wherein the device is preferably present in a manner integrated in a seat trim panel of the vehicle seat.

A seat trim panel preferably refers to a module which should be installed in a vehicle seat in particular and comprises the device according to the invention. This is intended to convey information and/or content, for example symbols, letters, numbers, images, logos, etc., with a particularly realistic and/or aesthetic impression to an observer.

Advantageously, the device may be designed such that the holographic image is visible from various directions within the vehicle compartment and also visible from the outside from the directions of the side windows and the front window.

Due to the low installation depth, it is possible to integrate the device into the seat trim panel without any problems. In addition, the device for creating the holographic image may preferably be completely concealed behind what is known as a black-panel surface, and so the device itself is not visible but appears as a black shiny surface when the light sources are not activated.

In a further aspect, the invention relates to a vehicle comprising a vehicle seat according to an aspect according to the invention.

A person of average skill in the art recognizes that advantages, definitions and embodiments of the device according to the invention also apply to the vehicle seat according to the invention and to a vehicle comprising such a vehicle seat, and vice versa.

The intention is to explain the aspects according to the invention in exemplary fashion below on the basis of figures without being restricted to these figures.

### FIGURES

### BRIEF DESCRIPTION OF THE FIGURES

FIG. 1 shows an approach from the prior art for creating a polychromatic holographic image.

FIG. 2 shows a schematic illustration of a preferred embodiment of the device according to the invention.

FIG. 3 shows a schematic illustration of a further preferred embodiment of the device according to the invention.

### DETAILED DESCRIPTION OF THE FIGURES

FIG. 1 shows an option known from the prior art for creating a polychromatic holographic image. For this purpose, a single light source 11 is used, which illuminates a holographic structure 7 of a light guide 3. The light source 11 is designed to emit light in different wavelength ranges. For example, this may be an RGB LED. A holographic structure 7 can be provided in the light guide 3 on an output coupling surface 9. The light of the light source 11 is input coupled via an input coupling surface 5 into the light guide 3 and is deflected via a deflection region 13 to the holographic structure 7. Thereupon, the light is output coupled via the output coupling surface 9 in order to create a polychromatic holographic image. The holographic structure 7 has a selectivity for at least two different color channels or wavelength ranges, and so a polychromatic holographic image can be provided under appropriate illumination of the holographic structure 7.

However, in a device according to FIG. 1 known from the prior art, so-called ghost images may arise when illuminating the holographic structure, which is designed for two color channels. For example, a ghost image is an unwanted color smear that occurs in the holographic image. In particular, this may result from the mutual influence of different color channels. The holographic structure 7 is designed to be wavelength-selective for the respective color channels. In the implementation, however, an occurrence of crosstalk between different color channels cannot be ruled out. In order to reduce this, it is possible in principle to optimize the quality of the holographic image to be displayed by virtue of adapting an angle of incidence 17 of the illumination radiation. For example, a smaller or steeper angle of incidence 17 may result in a higher selectivity of the holographic structure 7 and hence result in selectivity between the color channels.

However, the adaptation of an angle of incidence 17 may affect the required geometric dimensions of a light guide 3 or the overall device 1, as shown in FIG. 1. For a light guide 3 having a single deflection region 13 for guiding the radiation to an output coupling surface 9 with holographic structure 7, a smaller or steeper angle of incidence 17 requires an increase in the height 19 of the light guide 3, in particular with regard to the fact that a beam with a relatively large beam width must be guided through the light guide 7 in order to illuminate the entire holographic structure 7.

FIG. 2 schematically elucidates a preferred embodiment of the device 1 according to the invention. FIG. 2A shows the course of a beam path from a first light source 11a, while FIG. 2B clarifies the beam path from a second light source 11b.

The device 1 for creating a polychromatic holographic image comprises a light guide 3 comprising a first input coupling region 5a and a second input coupling region 5b for input coupling light into the light guide 3. The first light source 11a is designed to radiate light of a first wavelength range into the first input coupling region 5a. Accordingly, the second light source 11b is designed to radiate light of a second wavelength range into the second input coupling region 5b. Furthermore, the device 1 comprises a holographic structure 7 for creating the polychromatic holographic image under illumination by means of the first and second light sources 11a, 11b. The holographic structure 7 comprises a first region 7a, which is wavelength-selective for light of the first wavelength range, and a second region 7b, which is wavelength-selective for light of the second wavelength range. The light guide 3 is configured to guide the light from the first light source 11a to the first region 7a of the holographic structure 7 and the light from the second light source 11b to the second region 7b of the holographic structure 7.

For this purpose, the light guide 3 comprises a first deflection region 13a for deflecting the input coupled light from the first light source 11a to the first region 7a of the holographic structure 7 and a second deflection region 13b for deflecting the input coupled light from the second light source 11b to the second region 7b of the holographic structure 7. The deflection region 13a, 13b refers to a region situated on or within the light guide 3 and designed to steer input coupled light in the direction of the holographic structure 7 for the purpose of creating the polychromatic holographic image. The deflection regions 13a and 13b represent a reflection surface in the present case, wherein the reflection surface is present in a manner arranged at an interface of the light guide 3, and a deflection of the light is implemented by total-internal reflection at the interface.

The holographic structure 7 is arranged substantially parallel to an output coupling surface 9 and is configured to output couple light of the first wavelength range via a first output coupling region 9a of the output coupling surface 9 under illumination of the first region 7a and to output couple light of the second wavelength range via a second output coupling region 9b of the output coupling surface 9 under illumination of the second region 7b, in order to create the polychromatic holographic image.

By means of the device 1, a particularly low crosstalk between different color channels can be advantageously ensured during the creation of a polychromatic holographic image. By dividing the holographic structure into a first region 7a and second region 7b, which are wavelength-selective for the light from the first light source 11a and the second light source 11b, respectively, there is a clear separation of the positioning, the wavelength and the angle with which the first region 7a and the second region 7b are irradiated. Color smears in the form of ghost images are advantageously avoided.

Advantageously, the components of the device 1 can simultaneously be arranged in such a way that the device 1 requires only an extremely small installation space. A sharp separation of the color channels over a greater range of angles of incidence is achieved in particular by using two light sources 11a and 11b and dividing the holographic structure 7 into two regions 7a and 7b. In particular, it is thus possible to achieve sufficient separation even in the event of relatively flat or large angles of incidence.

As evident from FIG. 2, particularly small dimensions for the light guide 3 or the entire device 1 may be provided as a result. In this respect, it is also advantageous that in comparison with an illumination using a single light source, it is possible to use beams with a smaller width for the illumination of the separate regions 7a, 7b of the holographic structure 7 by the respective light sources 11a, 11b. The installation space depth can additionally be reduced by reducing the size of the hologram regions to be illuminated. As evident from the comparison with the variant of FIG. 1 discussed above, reducing a width of a beam of the illumination radiation allows both an extent of the deflection regions 13a and 13b in the light guide 3 and the height 19 of the light guide 3 to be reduced.

In this respect, the mirror-symmetrical structure shown in FIG. 2 with the configuration of the light guide 3 has proven to be particularly advantageous. In this case, the first 9a and second input coupling regions 9b, the first 13a and second deflection regions 13b and the light guide 3 may preferably be arranged substantially mirror symmetrically with respect to a plane of symmetry, which is orthogonal to an output coupling surface. In the cross section of the device 1 shown, the components are consequently arranged substantially mirror symmetrically with respect to a surface normal of an output coupling surface 9. By preference, this likewise applies to the light sources 11a and 11b and the optical components 15a and 15b for collimating the light.

As a result of the mirror-symmetrical arrangement shown, it is moreover ensured that the angles of incidence 17a, 17b between light beams from the first light source 11a and from the second light source 11b are substantially identical in terms of absolute value but have different signs.

The light of the first wavelength range is consequently guided onto the first region 7a of the holographic structure 7 at a first angle of incidence 17a in the direction of an output coupling surface 9 of the light guide 3. By contrast, the light of the second wavelength range is guided onto the second region 7b of the holographic structure 7 at a second angle of incidence 17b, wherein the light of the first and second wavelength ranges is guided from substantially opposite directions onto the output coupling surface 9 such that, by preference, the first angle of incidence 17a and second angle of incidence 17b are substantially equal in terms of absolute value but have different signs.

Crosstalk is avoided by illuminating the two regions of the holographic structure 7 at angles of incidence 17a, 17b with the same absolute value but different signs. Even in the event that, for example, stray light from the first light source 11a is guided onto the second region 7b in part, the different angle selectivities of the first and second regions 7a, 7b, in addition to preferred different wavelength selectivities, ensure a clear separation of the color channels.

Furthermore, by using two light sources 11a and 11b, it is possible to set an intensity of illumination of the separate regions 7a, 7b of the holographic structure 7 independently of each other. In particular, therefore, brightness levels of the holographic image at a specific wavelength as created by the corresponding regions can be optimized independently of each other. For example, a multicolored holographic image with a particularly uniform intensity for different wavelength ranges can be created as a result.

Moreover, the optical components 15a 15b for collimating the light of the different wavelengths may also be optimized independently of each other. For example, as shown, structurally identical lens elements may be used as optical component 15a and 15b for collimating the light of the first and second light sources 11a and 11b. By appropriately setting the distances of the optical components 15a and 15b from the respective light source 11a and 11b, it is possible to easily take into account different requirements with regard to the respective wavelength range.

FIG. 3 corresponds to a further preferred embodiment of the device 1 according to the invention. FIG. 3A shows the course of a beam path from a first light source 11a, while FIG. 3B clarifies the beam path from a second light source 11b.

The embodiment shown in FIG. 3 is substantially identical to the embodiment of FIG. 2. In contrast with the embodiment of FIG. 2, however, the light guide 3 is not designed as an isosceles trapezoid, in which the first input coupling region 5a and the second input coupling region 5b are present on a continuous input coupling surface. Instead, the first input coupling region 5a and the second input coupling region 5b are also arranged in a plane parallelly opposite to the output coupling surface 9, wherein, however, the outer surface of the light guide 3 does not extend continuously but has a recess between the input coupling regions (5a, 5b). For example, the recess may serve to reduce material provided that no guidance of light is necessary in the recessed, central region.

### LIST OF REFERENCE SIGNS

1 Device
3 Light guide
5 Input coupling surface
5a First input coupling region
5b Second input coupling region
7 Holographic structure
7a First region of a holographic structure
7b Second region of a holographic structure
9 Output coupling surface
9a First output coupling region
9b Second output coupling region
11 Light source
11a First light source
11b Second light source
13 Deflection region
13a First deflection region
13b Second deflection region
15 Optical component
15a First optical component
15b First optical component
17 Angle of incidence
17a First angle of incidence
17b Second angle of incidence
19 Height of the light guide
20 Width of the light guide

1. A device for creating a polychromatic holographic image, comprising
a. a light guide comprising a first input coupling region and a second input coupling region for input coupling light into the light guide,
b. a first light source designed to radiate light of a first wavelength range into the first input coupling region;
c. a second light source designed to radiate light of a second wavelength range into the second input coupling region;
d. a holographic structure for creating the polychromatic holographic image under illumination by means of the first and second light sources;
wherein
the holographic structure has a first region, which is wavelength-selective for light of the first wavelength range, and a second region, which is wavelength-selective for light of the second wavelength range, and wherein the light guide is configured to guide the light from the first light source to the first region of the holographic structure and the light from the second light source to the second region of the holographic structure.

2. The device as claimed in claim 1, wherein
a surface of the light guide forms an output coupling surface, wherein the holographic structure is preferably arranged substantially parallel to the output coupling surface and is configured to output couple light of the first wavelength range via a first output coupling region of the output coupling surface under illumination of the first region and to output couple light of the second wavelength range via a second output coupling region of the output coupling surface under illumination of the second region, in order to create the polychromatic holographic image.

3. The device as claimed in claim 1,
wherein
the first region and the second region of the holographic structure have no overlap region or an overlap region of less than 30%, of an overall area of the holographic structure.

4. The device as claimed in claim 1,
wherein
the first region and the second region of the holographic structure are separated from each other by a separation region, wherein the separation region has a lateral extent of at least 1 mm.

5. The device as claimed in claim 1,
wherein
the first light source and/or the second light source is a laser and/or an LED, wherein by particular preference the first light source is an RGB LED, and the second light source is a monochromatic LED.

6. The device as claimed in claim 1,
wherein
the first and/or second light source is designed to emit light with a wavelength between 380 and 780 nm, wherein by preference the first light source is a polychromatic light source and, in the first wavelength range, emits light of a spectrum with a width of at least 100 nm, and/or the second light source is a monochromatic light source and, in the second wavelength range, emits monochromatic light with a bandwidth of less than 50 nm.

7. The device as claimed in claim 1,
wherein
the light guide is formed by a monolithic substrate, wherein the substrate comprises a material which is an optical plastic.

8. The device as claimed in claim 1,
wherein
an output coupling surface of the light guide is arranged substantially parallel to opposing input coupling regions.

9. The device as claimed in claim 1,
wherein
the light guide is configured to guide light in the direction of an output coupling surface of the light guide at an angle of incidence that is greater than a critical angle for total-internal reflection and/or within an absolute value range between 50° and 80°.

10. The device as claimed in claim 1,
wherein
a height of the light guide is 10 mm to 50 mm, and/or a width of the light guide is 40 mm to 200 mm.

11. The device as claimed in claim 1,
wherein
the light guide comprises a first deflection region for deflecting the input coupled light from the first light source to the first region of the holographic structure and a second deflection region for deflecting the input coupled light from the second light source to the second region of the holographic structure

12. The device as claimed in claim 11,
wherein
between the first input coupling region and the first region of the holographic structure, the light is deflected exclusively by the first deflection region and experiences no further reflections, in particular total-internal reflection at interfaces of the light guide, and/or between the second input coupling region and the second region of the holographic structure, the light is deflected exclusively by the second deflection region and experiences no further reflections, in particular total-internal reflection at interfaces of the light guide.

13. The device as claimed in claim 11,
wherein
the first and/or second deflection region is a reflection surface, wherein the reflection surface is arranged at an interface of the light guide and causes a deflection of the light by way of a reflective coating or total-internal reflection at the interface.

14. The device as claimed in claim 1,
wherein
the first and second input coupling regions and preferably also a first and a second deflection region, are arranged substantially mirror symmetrically with respect to a plane of symmetry that is orthogonal to an output coupling surface.

15. The device as claimed in claim 1,
wherein
the light guide is configured to guide light of the first wavelength range onto the first region of the holographic structure at a first angle of incidence in the direction of an output coupling surface of the light guide and guide light of the second wavelength range onto the second region of the holographic structure at a second angle of incidence, wherein the light of the first and second wavelength ranges is guided from opposite directions to the output coupling surface such that the first and second angles of incidence are substantially the same in terms of absolute value but have different signs.

16. The device as claimed in claim 1,
wherein
the holographic structure is in the form of a volume hologram.

17. The device as claimed in claim 1,
wherein
the holographic structure is a transmissive holographic structure or a reflective holographic structure.

18. The device as claimed in
wherein
an optical component is arranged between the first light source and/or second light source and the light guide, wherein the optical component is configured to reduce a divergence of the light.

19. The device as claimed in claim 1,
wherein
a first optical component is arranged between the first light source and the light guide, and a second optical component is arranged between the second light source and the light guide, wherein the distances between the first light source and the light guide and between the second light source and the light guide have been independently optimized with respect to a collimation of the light of the respective light sources.

20. A light guide for a device for creating a polychromatic holographic image as claimed in claim 1,
wherein the light guide comprises a first input coupling region and a second input coupling region for input coupling light, and a holographic structure for creating the polychromatic holographic image,
wherein
the holographic structure has a first region which is wavelength-selective for light of a first wavelength range, and a second region, which is wavelength-selective for light of a second wavelength range, and wherein the light guide is configured to guide light which is radiated into the first input coupling region to the first region of the holographic structure and light which is radiated into the second input coupling region to the second region of the holographic structure.

21. A vehicle seat comprising a device as claimed in claim 1.

22. A vehicle comprising a vehicle seat as claimed in claim 21.
